(19) United States
(12) Patent Application Publication
(10) Pub. No.: US 2003/0093219 A1
(43) Pub. Date: May 15, 2003

(54) Four-dimensional route planner

(75) Inventors: Robert L. Schultz, Edina, MN (US); Donald A. Shaner, Shoreview, MN (US); Stephen Gregory Pratt, St. Louis Park, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell Inc.

(21) Appl. No.: 09/957,416

(22) Filed: Sep. 20, 2001

(51) Int. Cl. G01C 21/00

(52) U.S. Cl. 701/202; 701/209

(57) ABSTRACT

A route planner uses a recursive algorithm to determine a lateral path, and an adaptive algorithm to determine a vertical path. The vertical path is adjusted based on hazard areas represented by horizontal polygons having top and bottom altitudes. The route planner attempts to find a route which meets a required time of arrival window. A route may be broken into multiple starting and ending points, with desired arrival times specified for each ending point.

### REFERENCE TO RELATED APPLICATIONS

The present application is related to U.S. patent application: “Multi-Dimensional Route Optimizer”, Ser. No. 09/223,846, filed Dec. 31, 1998 assigned to the same assignee as the present application, and hereby incorporated by reference at least for its teaching of lateral route optimization using a recursive algorithm.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawing hereto: Copyright©2001, Honeywell Inc., All Rights Reserved.

### FIELD OF THE INVENTION

The present invention relates to route planners, and in particular a four-dimensional route planner.

### BACKGROUND OF THE INVENTION

For safety and efficiency reasons, aircraft routing is commonly along predetermined air routes or great circle routes. Predetermined air routes are often aligned with ground-based navigational aids. In some cases, air routes circumvent geographical regions. Great circle routes, on the other hand, promise shorter flight distances.

Weather affects both the efficiency and the safety of a particular flight. Aircraft efficiency improves with favorable winds. In suitable tailwinds, ground speed increases and fuel consumption drops. Reduced fuel consumption often means that additional revenue-generating payload can be carried. Increased ground speed means that flight times are reduced resulting in operational cost savings.

Similarly, hazardous weather can impose a wide variety of costs on aircraft operations. Such costs can range from an uncomfortable ride for passengers at the low end, to structural damage, and even loss of aircraft and lives, at the other extreme. Aircraft operators typically go to great length to avoid hazardous weather.

In addition, certain geographical and political regions are covered by restricted airspace. Such regions and severe weather are referred to as hazard areas. Flight in certain regions are preferably minimized because costly over flight fees may be imposed.

Achieving a desired arrival time is important because it allows the operator to more accurately schedule flights and enjoy greater operational efficiency. Aircraft operating on pre-determined air routes or great circle routes may be forced to make costly adjustments to airspeed in order to meet scheduling requirements.

Typical flight path routers plot a flight path in the lateral direction avoiding hazards and taking advantage of the winds, with the vertical portion of the path left to standard cruise profiles. Further flight path routers take into account the altitude of wind currents. Such routing usually fails to consider the vertical dimension of hazard areas and the time varying nature of the hazard areas, thus leading to less desirable routes. There exists a need for a system that addresses these shortcomings.

### SUMMARY OF THE INVENTION

A route planner uses a dynamic programming(DP) recursive algorithm to determine a lateral and vertical path. A cost function consisting of fuel, time, hazard costs, and overflight fees is minimized. Hazard areas are described by polygons having top and bottom altitudes. In one embodiment, the hazard areas are given a course and velocity, and thus move with time.

The route planner determines a course by moving from node to node in a grid of nodes established about an origin and destination. A local step cost is added to the accumulated cost to the next node. The transition step to the node which results in the lowest accumulated cost to the node is retained which results in finding the lowest cost route from the origin to the destination. When hazard areas are encountered, movement to new nodes is explored in multiple vertical paths in an attempt to find low cost transitions which do not pass through the hazard. If the step passes through a hazard the incremental hazard cost is added to the accumulated cost. In further embodiments, the route planner attempts to find a route which meets a required time of arrival window. A route may be broken into multiple starting and ending points, with desired arrival times specified for each ending point.

### BRIEF DESCRIPTION OF THE DRAWINGS

FIG. 1 is a block diagram of a route optimizer.

FIG. 2 is a computer screen shot of a user interface for the route optimizer of FIG. 1.

FIG. 3A is a plot showing a three dimensional representation of hazardous weather by a polygon having a top and bottom height.

FIG. 3B is a plot showing the top and bottom heights of the polygon of FIG. 3A.

FIG. 4 is a plot showing weather having a course and direction.

FIG. 5 is a computer screen shot of NCAR graded data showing hazard regions defined with polygon boundaries.

FIG. 6A is a three dimensional graphical representation of how to determine the length of a horizontal step in a hazard area.

FIG. 6B is a two dimensional graphical representation of how to determine the length of a horizontal step in an hazard area.

FIG. 7 is a representation of a flight path over country boundaries having entrance and exit points.

FIG. 8 is a projection of a step distance on a great circle plane.

FIG. 9A is a graphical representation of a region of convergence for trajectory iterations.

FIG. 9B is a graphical representation of a region of convergence for trajectory iterations.

FIG. 10A is a representation of a three dimensional grid of nodes used by the route optimizer.

FIG. 10B is a graphical representation of lateral steps to be explored from a given node.

FIG. 10C is a graphical representation of vertical steps to be explored from a given node.

FIG. 10D is a graphical representation of combined lateral and vertical steps to be explored from a given node.

FIG. 11 is a graphical representation of the recursive process used to determine a lateral path.

FIG. 12 is a graphical representation of different types of transitions through weather.

FIG. 13A is a graphical representation of a transition from an altitude in weather.

FIG. 13B is a graphical representation of a transition from an altitude not in weather.

FIG. 14 is a three dimensional representation of a geometry for route planning showing a hazard, country overflight fees and wind fields.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

Software for the system is stored on computer readable medium. In one embodiment the software is stored on secondary storage, such as a disk drive and loaded into main memory and cache of the computer as needed. The software is written in the form of modules that generally provide a single function or subsets of related functions. However, in various embodiments, the software comprises a single module or many modules, and there is no requirement that functions be grouped together. Hardware and/or firmware is used to implement the invention in further embodiments. The software may implement the functions, or simply facilitate the performance of the function by a human by providing menu driven interfaces, or other means of providing information to the system for database storage.

Route optimization for a vehicle, such as an aircraft is provided by the route optimizer of the present invention. The route optimization consists of a lateral path and a vertical path. The lateral path is determined largely in accordance with US patent application: “Multi-Dimensional Route Optimizer”, Ser. No. 09/223,846, filed Dec. 31, 1998 assigned to the same assignee as the present application, and which is hereby incorporated by reference for its teaching of lateral route optimization using a recursive algorithm.

The vertical path is determined by use of an adaptive algorithm, which takes into account three dimensional hazard areas. The three dimension hazard areas are represented as polygons having a height and, which may also have velocity and direction component.

A definitions section is first provided, followed by an overview of the route optimizer from a high level. Next, representations of hazard areas are defined, followed by further detail regarding how vertical and horizontal paths are calculated, taking such hazard areas into account.

Definitions:

C_{L}—coefficient of lift

C_{d}—coefficient of drag

CI—cost index

CF—cost function

D—drag

D_{gc}—great circle distance flown

FFR—fuel flow rate

h—altitude

h(k₀)—altitude from previous grid point

hᵤₚₚₑᵣ—

h_{lower}—

L—lift

M—Mach number

MTOW—maximum take off weight

m_{f}—mass of fuel

sos—speed of sound

V—ground speed

Vₐ—air speed

V_{W}—wind speed

W—weight

W_{f}—weight of fuel

R—charge for overflight

RTA—required time of arrival

Sₐ—aerodynamic reference area

S—arclength distance traveled

T—Unit rate in overflight fees

ΔS—step in arclength distance traveled

θ—longitude

φ—latitude

π—throttle

ψ—direction of great circle for overflight fees

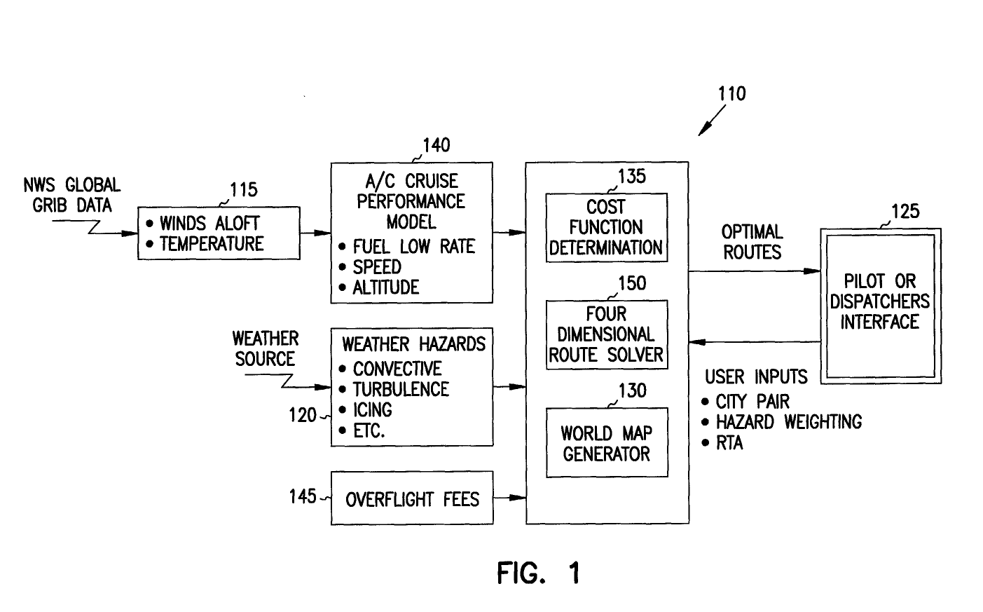

The route solver, represented generally at 110 in FIG. 1, computes a four-dimensional (three positions and time) route that minimizes a composite cost function consisting of fuel, time, hazard costs, and overflight fees, and meets required times of arrival (RTA's). Route solver 110 is hosted in a digital computer with a video monitor in one embodiment. A processor receives wind and temperature information 115 such as from NWS Global GRIB Data, which provides the solver with representations of winds aloft and temperature. Weather information is received at 120, and is representative of convective currents, turbulence, icing, etc. This information is also provided from an outside source, and may be input by a user of the solver via an interface 125, used by pilots, and/or dispatchers.

The processing element are: Pilot or dispatcher Interface 120; World Map Generation 130; Cost Function Determination 135; Weather Hazards Generation 120; Wind generation 115; Aircraft Cruise Performance—Fuel Flow Rate, Speed and Altitude 140; Overflight fees 145; and Four Dimensional Route Solver 150.

1.1 Pilot or Dispatchers Interface

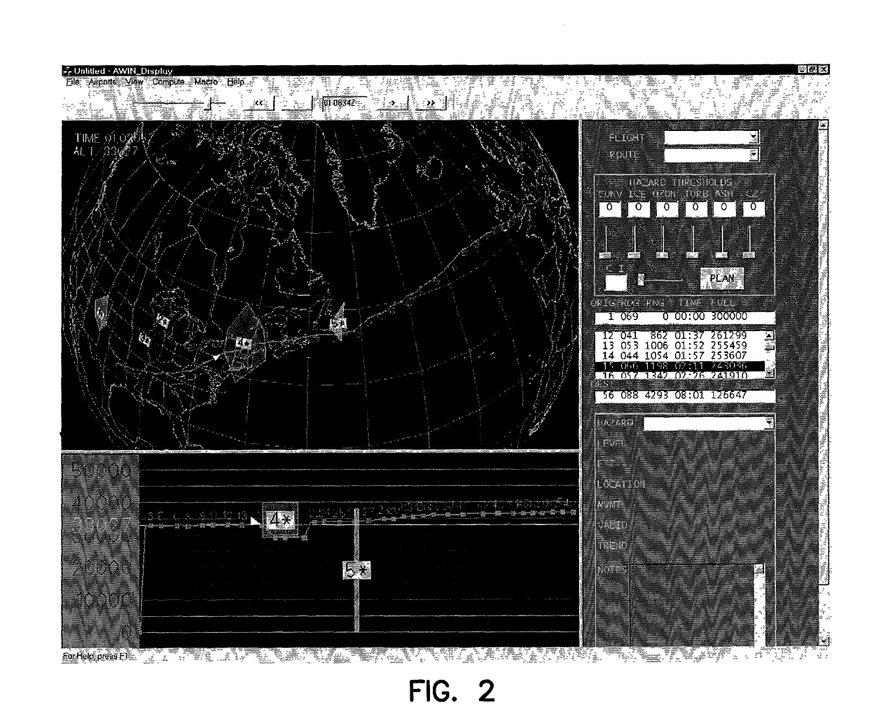

The operator, pilot or dispatcher can interact with the route solver through the user interface 125. One screen shot of the user interface is shown in FIG. 2. The operator can enter the origin, destination, required time of arrivals, stopping points along the route, hazards, such as severe weather, volcanic ash, special use airspace, and politically sensitive regions, hazard weightings, and required time of arrival. Prior to selecting a time of arrival, the operator can ask for a computation of the time of arrival window. The operator views the route planning situation on a world map of countries with overlays of wind fields, and hazards. Hazards are shown as polygons, and are labeled. Two hazards in FIG. 2 are labeled 4* and 5*. Their heights are shown in lower frame below the world view.

The operator can enter a city pair, hazards, hazard weightings, and required time of arrival. After computing the horizontal route is displayed over the word map. The vertical route with the hazards overlain is also displayed. A window containing the performance results of fuel time average speed and cost can be selected. The operator can affect the route by changing the hazard weightings.

1.2 Route Determination Method

The routes are computed using a dynamic programming (DP) method. In DP a search is conducted over a grid to find the path that minimizes a cost function. The cost function includes fuel, time, hazard costs, and overflight costs. The total cost is the sum of incremental costs which are

ΔCost=ΔCost_{fuel}+ΔCostₜᵢₘₑ+CₕΔcost_{hazard}+Δcost_{overflight}

Following is a description of each term in the cost function.

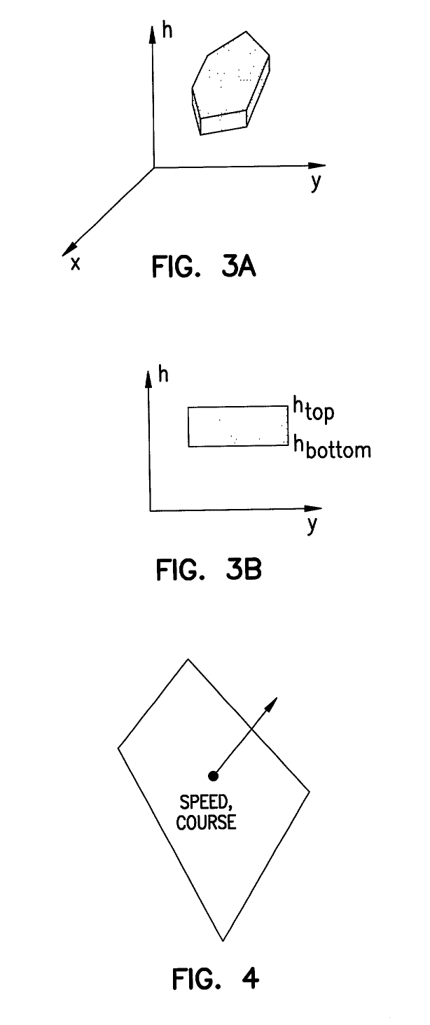

Hazard Costs—Hazards are severe weather, volcanic ash, special use airspace, and politically sensitive regions. All of the hazard costs are determined in a similar manner. The hazard representation is three dimensional as shown in FIG. 3A which shows a perspective view of the hazard representation. FIG. 3B shows the height of the hazard representation, as having a top height and a bottom height. Some hazard areas may have bottom heights of ground level and top heights beyond the range of the aircraft. Hazard polygons move at a fixed course and speed starting from some reference time as shown in FIG. 4.

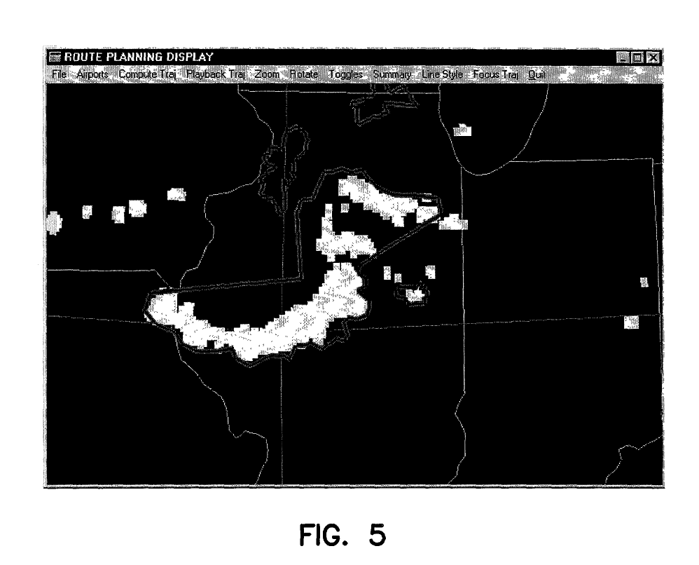

The weather costs represent the danger of flying through severe weather regions. The weather hazards are categorized into convection, turbulence, and icing. The weather regions are represented as polygons which enclose the severe weather region as shown in FIG. 5. The polygon is shown as a double line surrounding white squares which are indicative of actual radar returns of hazardous weather. In one embodiment, the polygon has multiple vertices, which are either selected by an operator of the system, or automatically generated from weather information.

The hazard data base consists of the vertices of the polygon, speed, course, the tops and bottoms of the region, and the associated danger costs, which can be user entered in FIG. 2.

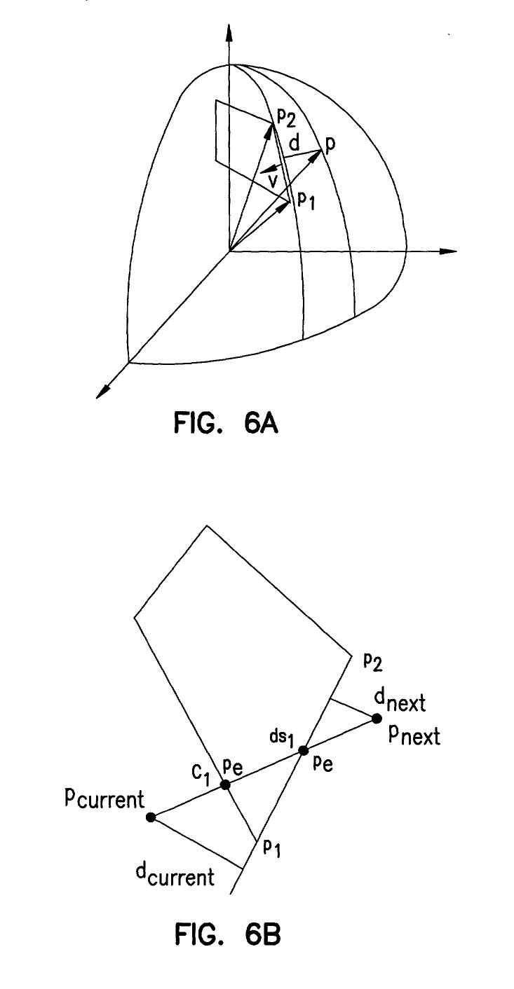

The hazard costs depend on the danger cost of the particular cell and the distance traveled during the step. The method of determining the length of the horizontal step in the hazard is shown in FIGS. 6A and 6B.

To compute the distance it is assumed that the region is a convex polygon with points specified in a counterclockwise order. The steps are as follows.

For each polygon segment determine d

v=pᵢ×pᵢ₊₁

d=v·p

For each polygon segment, define dₙₑₓₜ, d_{current} corresponding to Pₙₑₓₜ, P_{current}.

If dₙₑₓₜ, d_{current} <0=> then segment is outside, so quit

else, if dₙₑₓₜ <0, d_{current}>0=> then clip Pₙₑₓₜ

else, if dₙₑₓₜ >0, d_{current}<0=> then clip P_{current}

Where the clip function for pₙₑₓₜ is

$${p}_{e} = \frac{{d}_{next} \cdot {p}_{current} + {d}_{current} \cdot {p}_{next}}{\vert {d}_{next} + {d}_{current} \vert} {p}_{next clipped} = {p}_{e}$$

Once the route segment is processed against each polygon, the intersection (Δs₁) of the polygon and the original route segment is

Δs₁=\sqrt{(p_{next clipped}−p_{current clipped})·(p_{next clipped}−p_{current clipped})}

The hazard cost is scaled with the ratio of the distance in the hazard (Δs₁) to the step distance (Δs)

$${cost}_{hazard} = \frac{Δ {s}_{1}}{Δ s} {cost}_{hazard} ( φ , θ , h , t )$$

Fuel and Time Costs—Fuel and time costs are determined from aircraft optimal cruise performance conditions. There are two different types of cruise performance. If there are no hazard areas, the cruise altitude and speed are free to be chosen to optimize the cruise cost function. If there are hazard areas, the cruise altitude may be specified, e.g., the top or bottom altitude of the hazard areas. Thus, there are two possible cruise solution types: 1) unconstrained cruise—the altitude is free to be chosen, and 2) constrained altitude cruise—the altitude is specified.

In cruise, the cost integral (C) in minimized.

$$C = {\int }_{0}^{{S}_{f}} ( \frac{ⅆ {m}_{f}}{ⅆ s} + CI \frac{1}{V} ) ⅆ s$$

CI is the ratio of cost of time (in monetary units) to the cost of fuel (in monetary units). More emphasis can be put on time by increasing the cost index(CD. For a small arclength step AS, the fuel, time and cost increments are

$$Δ Fuel = \frac{ⅆ {m}_{f}}{ⅆ s} Δ S$$

$$Δ t = \frac{1}{V} Δ S$$

$$Δ {Cost}_{ft} = Δ Fuel + CI Δ t$$

Traditionally, the fuel/time cost are combined into a single cost function (CF).

$$CF = \frac{FFR + CI}{V}$$

Then

ΔCost=CFΔs

The fuel/time cruise performance solutions are pre-computed by the aircraft manufacturer and then supplied to the user in tables as a function of the parameters: weight, cost index, wind speed and altitude. The two types of cruise models are:

Unconstrained Altitude Cruise—Altitude Not Specified

$$Δ {Cost}_{ft} = CF ( W , CI , {V}_{w} ) Δ s$$

$${h}_{cruise} = h ( W , CI , {V}_{w} )$$

$$V = CF ( W , CI , {V}_{w} )$$

$$\frac{ⅆ {w}_{f}}{ⅆ s} = \frac{ⅆ {w}_{f}}{ⅆ s} ( W , CI , {V}_{w} )$$

Constrained Altitude Cruise—Altitude Specified

$$Δ {Cost}_{ft} = CF ( W , CI , {V}_{w} , h ) Δ s$$

$${h}_{cruise} = h$$

$$V = CF ( W , CI , {V}_{w} , h )$$

$$\frac{ⅆ {w}_{f}}{ⅆ s} = \frac{ⅆ {w}_{f}}{ⅆ s} ( W , CI , {V}_{w} , h )$$

When the aircraft is in a free cruise the unconstrained altitude solution is used. When the aircraft is forced to fly at an altitude above or below the free cruise altitude the constrained altitude solution is used. The above models are typical of those used in flight management systems.

Overflight Fees—In general overflight fees depend on weight, distance traveled and rate (cost per distance). The overflight fees are computed differently for each country. Some fee types are a fixed rate, a function of weight, and a function of weight, distance, and rate. Following are some formulas used:

### Formula #1 (Eurocontrol Countries and Others)

$$R = T {D}_{gc} \sqrt{\frac{W}{50}}$$

where

R=charge

T=Unit rate

D_{gc}=great circle distance flown

W=maximum take off weight (MTOW) in metric tons

### Formula #2 (ASECNA Countries)

R unit rate×coefficient (determined from Table 1)

TABLE 1
Coefficient Table

| Weight | Distance in | | | |
|---|---|---|---|---|
| Metric | kilometers | | | |
| Tons | 0-750 | 750-2000 | 2000-3500 | Over 3500 |
| 14-20 | 1 | 5 | 12 | 20 |
| 20-50 | 1.2 | 6 | 14.4 | 24 |
| 50-90 | 1.4 | 7 | 16.8 | 28 |
| 90-140 | 1.6 | 8 | 19.2 | 32 |
| 140-200 | 1.8 | 9 | 21.6 | 36 |
| 200-270 | 2.0 | 10 | 24 | 40 |
| 270-350 | 2.15 | 10.75 | 25.8 | 43 |
| 350-440 | 2.3 | 11.5 | 27.6 | 46 |
| 440-540 | 2.45 | 12.25 | 29.4 | 49 |
| 540-650 | 2.6 | 13 | 31.2 | 52 |

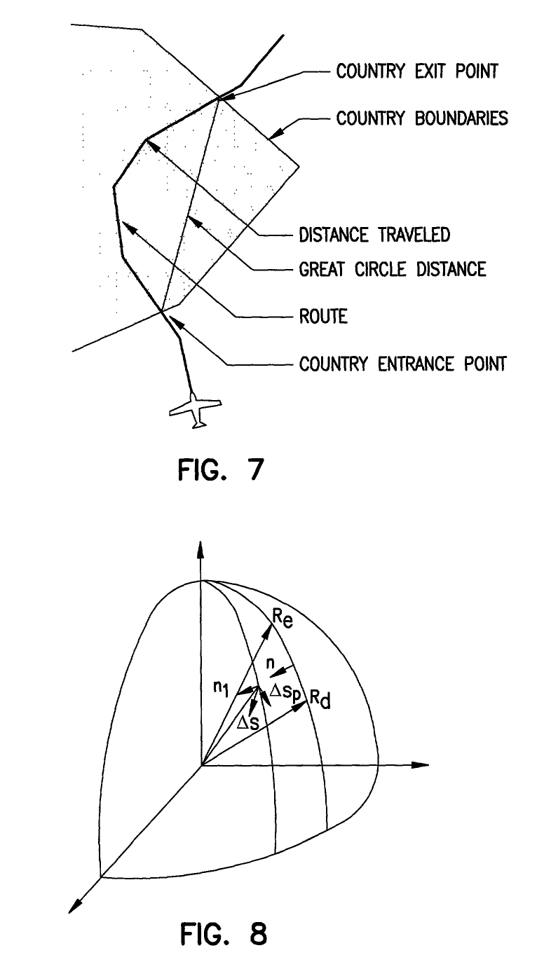

The distance may be the actual distance flown, or the great circle distance between the entrance point and the in country destination airport, or exit point, or the great circle distance between the in country origin airport and country exit point. The difference between the distance traveled and the great circle distance is shown in FIG. 7. The country boundary is the political boundary, the ATC Flight Information Region (FIR), or a combination of both.

To compute the great circle distance, the projection of the step distance (ΔS) on the plane of the great circle defined by the country entrance and departure point is used (see FIG. 8). The normal to the plane containing the entrance point (Rₑ) and the departure point (R_{d}) is

$$\overline{n} = \frac{{\overline{R}}_{e} \times {\overline{R}}_{d}}{\vert {\overline{R}}_{e} \times {\overline{R}}_{d} \vert}$$

The components of n in the earth-centered coordinate system are rotated to the coordinate system at the current point with the x axis pointing out from the earth.

n^{R}=T(φ, θ)n^{e}

Next the projection of n on the local vertical at the current point R, (\overline{n}₁), is determined by setting the vertical component of \overline{n} at R to zero.

$${n}_{x} = 0$$

$$d = \sqrt{{n}_{y}^{2} + {n}_{z}^{2}}$$

$${n}_{ly} = \frac{{n}_{y}}{d}$$

$${n}_{lz} = \frac{{n}_{z}}{d}$$

The projection of ΔS is then

Δ\overline{S}ₚ=Δ\overline{S}×\overline{n}₁

Trajectory iterations are required to compute overflight costs when the distance factor is the great circle distance. On the first iteration, during the run the arc length is used for the distance instead of the great circle distance. Also on the first iteration the country entrance and departure points are computed at the end of the run during the retrace. On subsequent iterations, the country entrance and departure points from the previous pass are used in the computation of the great circle distance.

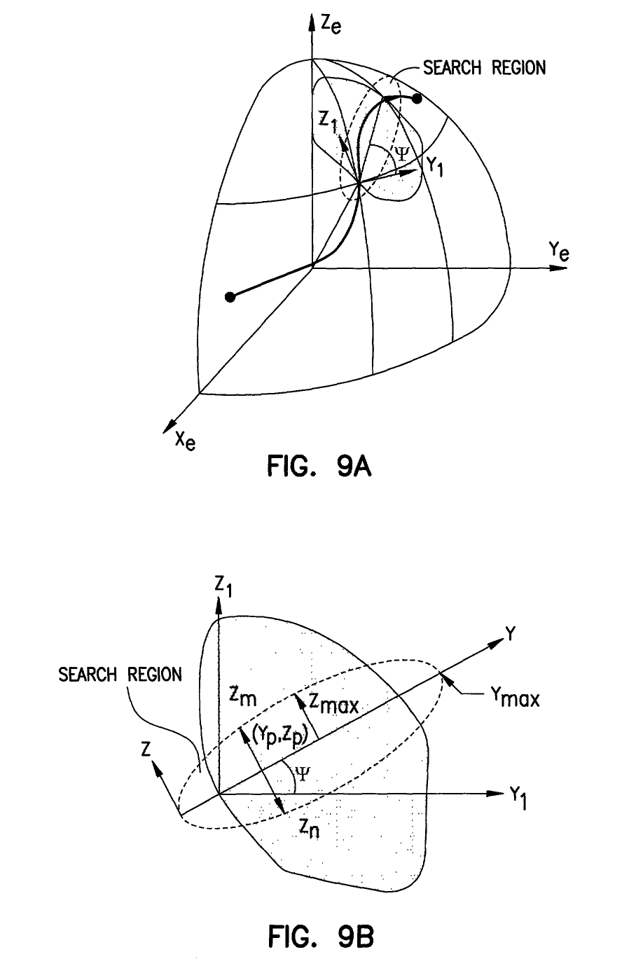

To aid in convergence of the iteration process, after the first iteration, the region of search for the route is limited to a region around the previous route as shown in FIG. 9A and FIG. 9B.

The following equations are used to determine if the point is in the region.

The distance between the entrance point and the departure point in earth coordinates is

ΔRₚₓ=R_{dx}−Rₑₓ

ΔR_{py}=R_{dy}−R_{ey}

ΔR_{pz}=R_{dz}−R_{ez}

The relative distance in the local vertical frame is

ΔRₓ=cos φ cos θΔRₑₓ+cos φ sin θΔR_{ey}+sin φΔR_{ez}

ΔR_{y}=sin θΔRₑₓ+cos θΔR_{ey}

ΔR_{z}=−sin φ cos θΔRₑₓ−cos φ sin θΔR_{ey}+cos φΔR_{ez}

The angle between the local vertical frame and a frame with the y axis along the great circle is

$$Ψ = {tan}^{- 1} ( \frac{Δ {R}_{z}}{Δ {R}_{y}} )$$

The search region is defined by

yₘₐₓ=cos φΔR_{y}+sin ψΔR_{z}+2k

zₘₐₓ=500 nm

k=100 nm

The components of the current relative position, measured from the entrance point, in the earth frame is:

ΔRₚₓ=Rₚₓ−Rₑₓ

ΔR_{py}=R_{py}−R_{ey}

ΔR_{pz}=R_{pz}−Rez

The components of the current relative position (ΔRₚ) in the local vertical frame are:

ΔRₚₓ=cos φ cos θΔRₚₑₓ+cos φ sin θΔR_{pey}+sin φΔR_{pez}

ΔR_{py}=sin θΔRₚₑₓ+cos θΔR_{pey}

ΔR_{pz}=−sin φ cos θΔRₚₑₓ−cos φ sin θΔR_{pey}+cos φΔR_{pez}

The current relative position is the rotated frame is:

y=cos ψΔR_{py}+sin ψΔR_{pz}

z=−sin ψΔR_{py}+cos ψΔR_{pz}

The z boundary point at y is:

$${z}_{1} = - 4 {( \frac{{z}_{max}}{{y}_{max}} )}^{2} [ {( y + k )}^{2} + {y}_{m} ( y + k ) ]$$

$${z}_{1} = + 4 {( \frac{{z}_{max}}{{y}_{max}} )}^{2} [ {( y + k )}^{2} + {y}_{m} ( y + k ) ]$$

The following equations are used to determine if the point (y,z) is inside the search region.

if(z≦z₁ and z≧z₂)then inside the region and

$$sf = 1.05 \frac{Δ {s}_{p}}{Δ s} ; if ( sf \geq 1 ) sf = 1. ; sf = scale factor$$

else outside of region then

sf=10

end

The distance used in the overflight fee computation is the scale factor times the step distance

d=sfΔS

Thus there is a large penalty for being outside the region.

1.2 Four Dimensional(4-D) Dynamic Programming Route Solver

The following is a description of the four-dimensional (latitude, longitude, altitude, and time) route solver. First the three-dimensional dynamic programming route solver is described, then, the Multiple Point Required Time of Arrival (RTA) function is described.

In a dynamic programming (DP) method a 3-D grid search is conducted to minimize a cost function. The DP solution equations consist of a set of state transition equation and a recursion equation for minimizing the costs. The general form of the DP equations are:

State Transitions

θₖ₊₁=θₖ+Δθ

φₖ₊₁=φₖ+Δφ

hₖ₊₁=hₖ+Δh

Recursive Cost

$${C}_{i + 1} ( {x}_{k + 1} ) = {min}_{Δ φ , Δ θ , Δ h} [ {C}_{i} ( {x}_{k} ) + Δ {C}_{i , i + 1} ( {x}_{k + 1} , {x}_{k} , Δ φ , Δ θ , Δ h ) ]$$

$${x}_{k} = ( {θ}_{k} , {φ}_{k} , {h}_{k} )$$

$$Δ φ , Δθ , Δ h = controls$$

A fixed pattern search is used in the horizontal axis, however, an adaptive search is used in the vertical axis to reduce the number of calculations.

The computation starts at the origin and ends at the destination this allows the hazard location to be propagated forward in time using the course and speed. Starting at the origin also allows the recalculation of the route during flight because the state conditions including weight are known.

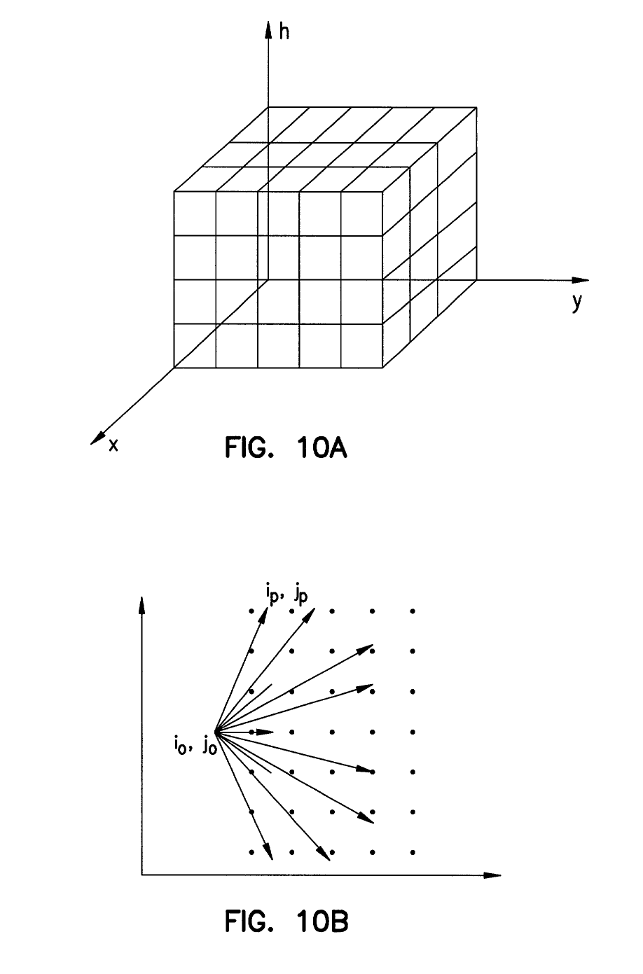

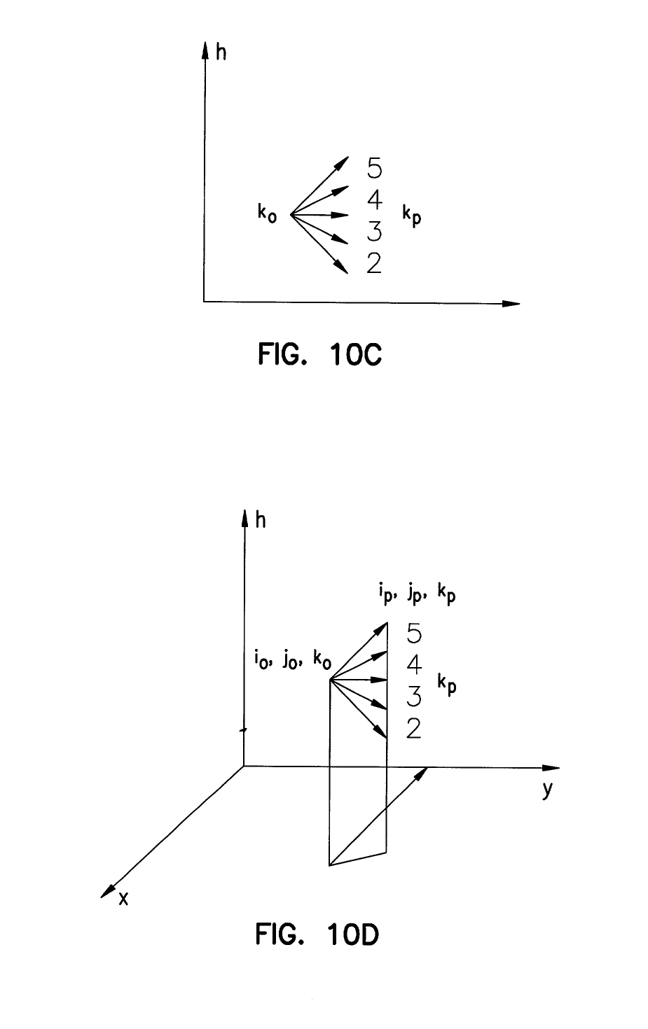

The three dimensional grid and transitions types between the grid points are shown in FIGS. 10A, 10B, 10C and 10D. Origin and destination points are contained within the three dimensional grid in FIG. 10A. In FIG. 10B, eleven potential lateral steps are shown. In further embodiment, fewer or more potential steps may be explored, even directions away from the destination. As indicated, the distance of each step depends on the grid point being moved to. In FIG. 10C, five different vertical steps from a node are shown. Fewer or may be explored. FIG. 10D is a graphical representation of a combination of horizontal or lateral and vertical steps.

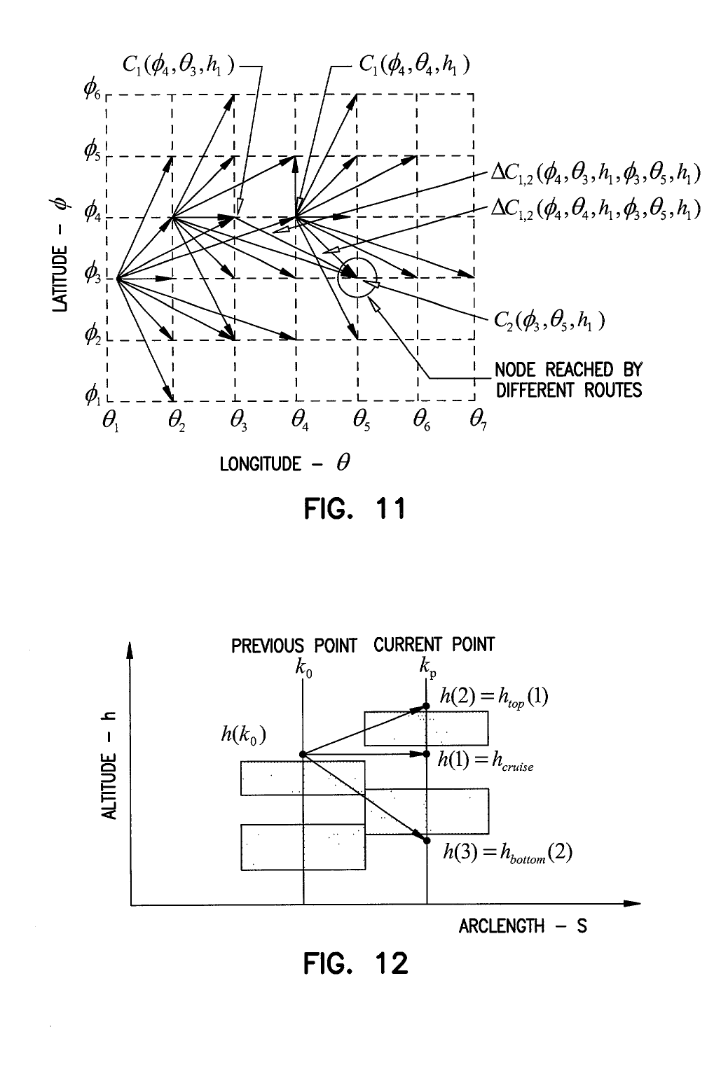

An illustration of the DP process is shown in FIGS. 11 and 12. In FIG. 11 the first and second stages of the process in the horizontal axis are shown. In this example, for each entry heading direction, there are nine heading exit directions. For each horizontal transition, a number of vertical transitions are examined, as shown in FIG. 12. The vertical transitions are not predetermined, as is the case for the horizontal transitions, but depend on the location and number of hazard cells. That is, the vertical search adapts itself to the situation before it. This adaptive search approach reduces the number of calculations that must be performed.

The vertical transition altitudes are different for different configurations of overlapping hazards. The altitude assignment depends on the location of the unconstrained cruise altitude with respect to the multiple hazard cells. First the location of the unconstrained cruise altitude is found, then depending on its location, the other transition altitudes, are assigned to the tops and bottoms of hazard cells. In the example shown in FIG. 12, the unconstrained cruise altitude is between the weather cells. In this case, the cruise altitude is assigned altitude h(1), the top of cell(1) is assigned altitude h(2), and the bottom of cell(2) is assigned h(3).

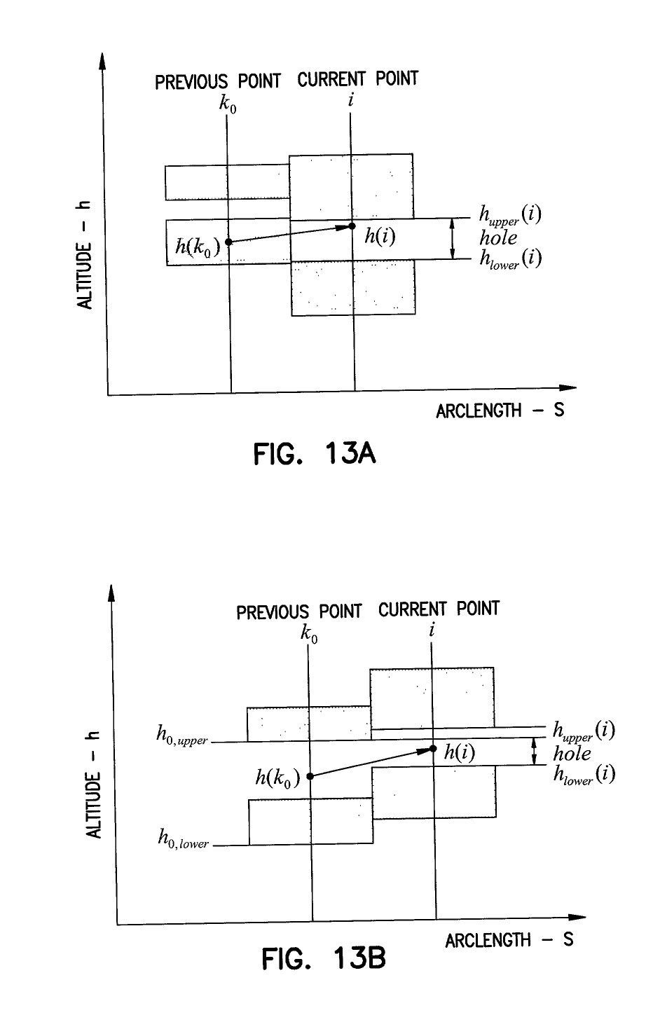

For the current step the incremental transition cost is computed. The transition cost includes the cost of fuel, time, overflight fees, and the hazard cost if the hazard is passed through on the step. To determine if the vertical transition passes through weather, it is determined if a hole exists between the hazard cells between the two points. An example of the hole calculation for two hazard configurations is shown in FIG. 13A and FIG. 13B. FIG. 13A shows a transition from a node in weather to a node not in weather. FIG. 13B shows the transition between two points not in weather, and wherein the path does not cross weather.

The following logic determines if a hole exists and the hole size. First the upper and lower altitude bounds for the space around the previous altitude are stored at the grid point, and also the upper and lower bounds for the space around the current point are computed. Then, the following is computed.

a) Previous Altitude in Weather (See FIG. 13A)

i=altitude being transition to (i=1,jᵥₗₑᵥₑₗₛ)

If h(k₀)<hᵤₚₚₑᵣ(i) and h(k₀)>h_{lower}(i), then a hole exists

hole_{size}=hᵤₚₚₑᵣ(i)−h_{lower}(i)

b) Previous Altitude Not in Weather (See FIG. 13B)

if(hᵤₚₚₑᵣ₀<hᵤₚₚₑᵣ(i))then

hole_{high}=hᵤₚₚₑᵣ₀

else

hole_{high}=hᵤₚₚₑᵣ(i)

endif

if(h_{lower0}<h_{lower}(i))then

hole_{low}=h_{lower0}

else

hole_{low}=h_{lower}(i)

endif

hole_{size}=h_{high}−h_{low}

c) Hole Existence

if (hole_{size}>1000 ft. ) then a hole exists

If the hole exists, then the transition does not pass through the weather. The transition costs then

$$Δ C = \{ \begin{matrix}{( Δ fuel + CI Δ t )}_{{h}_{free}} ; & if transitioning to unconstrained cruise and no hazard is encountered \\ {Δ fuel + CI Δ t )}_{{h}_{free}} + Δ {C}_{hazard} ; & if transitioning to unconstrained cruise and a hazard is encountered \\ {Δ fuel + CI Δ t )}_{{h}_{specified}} ; & if transitioning to constrained cruise and no hazard is encountered \\ {Δ fuel + CI Δ t )}_{{h}_{spefified}} + Δ {C}_{hazard} ; & if transitioning to constrained cruise and a hazard is encountered\end{matrix}$$

Finally the total accumulated cost is computed from the cost recursion formula

C(iₚ, jₚ, kₚ)=C(i₀, j₀, k₀)+ΔC

If the point has been reached before the previous cost is compared to the current cost. If the total current cost is lower than the total cost stored at the node, then, the new cost, the direction of entry, altitude, weight, time, hᵤₚₚₑᵣ, and h_{lower} are stored at the grid location iₚ,jₚ,kₚ. The altitude grid point location (kₚ) cooresponding to the transition altitudes, is

$${k}_{p} = integer ( \frac{h ( {k}_{v} )}{Δ h} + .5 )$$

where

kᵥ=vertical transition number (kᵥ=1,3 for illustration in FIG. 12)

The quantities stored at each grid point are:

C(iₚ,jₚ,kₚ)=C(i₀,j₀,k₀)+ΔC

hor_entry(iₚ,jₚ,kₚ )=entry_direction

vert_entry_{direction}(iₚ,jₚ,kₚ)=kₚ−k₀

weight(iₚ,jₚ,kₚ)=weight(i₀,j₀,k₀)−Δw

time(iₚ,jₚ,kₚ)=time(i₀,j₀,k₀)−Δt

h(iₚ,jₚ,kₚ)=h(kᵥ)

hᵤₚₚₑᵣ(iₚ,jₚ,kₚ)=hᵤₚₚₑᵣ(kᵥ)

h_{lower}(iₚ,jₚ,kₚ)=h_{lower}(kᵥ)

Note that even though the altitude grid is quantized to a number of discrete levels, the actual altitude (e.g., the unconstrained cruise altitude) is known more accurately because it is stored at the discrete location and can be retrieved.

The multiple RTA (required time of arrival) function plans trajectories that meet a time of arrival at multiple points along the trajectory. The Multiple RTA's approach is a sequential approach. First a trajectory that meets the time of arrival at the first city is computed. Next the trajectory meeting the time of arrival to each subsequent city or location is determined. The RTA at each point is achieved by trajectory iterations between current point and the next point. On the first iteration a cost index is selected. After the first trajectory is computed the time of arrival error is computed and the cost index is changed with the time of arrival error and the trajectory recomputed.

CIᵢ₊₁=CIᵢ+KΔTᵢ

After achieving the desired time of arrival at the next point the process is repeated for each subsequent point. The initial conditions for weight and time for the start of the next sequence are the weight and time at the end of the previous process. The sequential data is summed to determine the fuel usage and average speeds.

The RTA Window function determines the earliest and latest possible time of arrival. The earliest time of arrival trajectory is determined by setting CI=CIₘₐₓ. The latest time of arrival is determined by setting CI to the maximum endurance value (CIₘᵢₙ). The flight is computed with this setting and then an extension to the flight is simulated until the remaining fuel reaches the reserve level. This extended cruise estimates the fuel and time that would be used in a holding pattern or another route extension maneuver.

### CONCLUSION

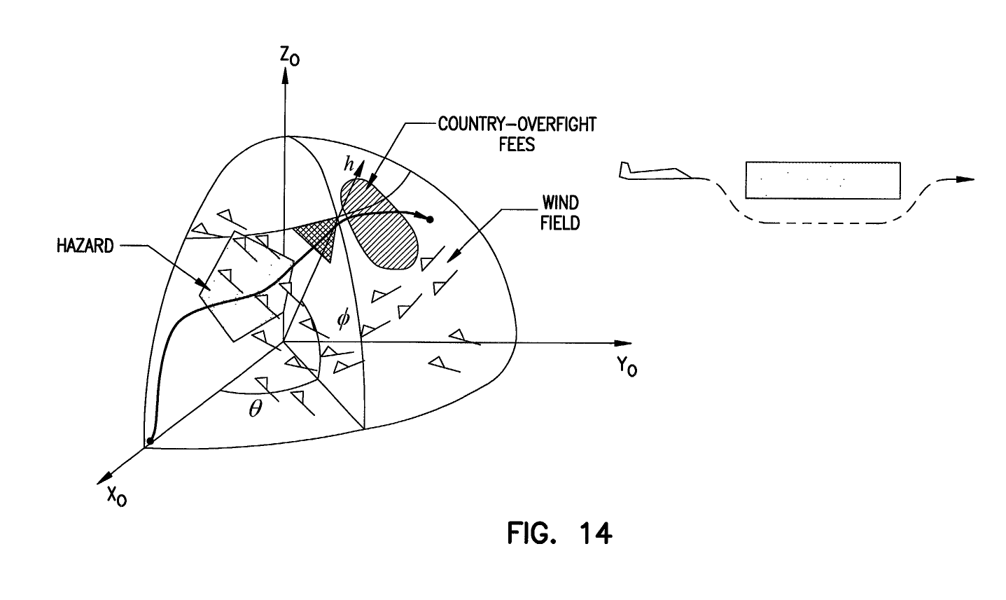

The route solver provides an aid to airlines dispatchers or pilots to help them plan routes. In general when planning flights the pilot or dispatcher wants to minimizing fuel, time and over-flight fees, avoid hazard regions such as severe weather (convection, turbulence, and icing), special use airspace, volcanic ash and environmentally and politically sensitive regions. The routing problem is illustrated in FIG. 14. For best fuel and time performance the best route may follow wind profiles and may fly around, above or below hazard regions.

Routes are found that satisfy one or more of the following diverse goals:

Minimize the amount of fuel

Meet a time or time window or minimize flight time

Avoid severe weather regions

Avoid other hazard regions such as special use airspace, volcanic ash, environmentally sensitive regions

Avoid politically sensitive regions

Reroute in flight to a nearest or desirable airport in the cases of non-normal events

The inclusion of hazard cost in the cost function guarantees a solution even if the extent of the hazard is across the entire search area. By starting at the origin and proceeding to the destination, hazard positions can be projected forward in time to provide a better solution.

1. A method of determining a route between an origin and a destination comprising:
beginning at the origin, determining multiple feasible segments from the origin to a node at the end of each feasible segment;
varying altitude as a function of three dimensional representations of hazard areas;
iteratively determining further segments from the nodes to create multiple segment paths between the origin and the destination; and
determining the segment path between the origin and destination having the least cost.

2. The method of claim 1 wherein an hazard area is represented by a polygon having vertices in a lateral plane and a height.

3. The method of claim 2 wherein the hazard area is represented by multiple polygons having different heights.

4. The method of claim 2 wherein the hazard area is associated with a velocity vector.

5. The method of claim 1 wherein the hazard areas are selected from the group consisting of weather hazards, volcanic ash, special use airspace and politically sensitive regions.

6. The method of claim 1 wherein the hazard area is moved in accordance with a velocity vector during determination of the segment path.

7. A method of determining a route, comprising:
receiving an origin node;
receiving a destination node, the destination node located a distance from the origin node;
creating a grid comprising the origin node, the destination node, and a plurality of en route nodes, each node having a plurality of altitudes;
determining the cost to transition to the destination node and each of the plurality of en route nodes;
varying the altitude as a function of three dimensional hazard areas; and
selecting a subset of nodes from the plurality of en route nodes, the subset of nodes having the least total cost to transition from the origin node to the destination node.

8. The method of claim 7 wherein receiving an origin node comprises receiving an origin node expressed in global coordinates and receiving a destination node comprises receiving a destination node expressed in global coordinates, and further comprising:
transforming the global coordinates of the origin node into a coordinate system wherein the origin lies on an equator; and
transforming the global coordinates of the destination node into a coordinate system wherein the destination lies on the equator.

9. The method of claim 7 wherein determining the cost to transition comprises evaluating a cost function, the cost function comprising a factor for fuel.

10. The method of claim 7 wherein determining the cost to transition comprises evaluating a cost function, the cost function comprising a factor selected from the group of time, overflight fees, and hazard costs.

11. The method of claim 7 wherein selecting a subset of nodes from the plurality of en route nodes comprises iteratively calculating the cost to transition from each node to each of a plurality of subsequent nodes.

12. A method of selecting a lateral and vertical route, comprising:
receiving an origin node;
receiving a destination node, the destination node remote from the origin node;
defining a plurality of paths, each path originating at the origin node and terminating at the destination node and traversing one or more intermediate nodes;
defining more intermediate nodes at varying altitudes in response to hazards which are defined with lateral and vertical dimensions;
defining more paths utilizing the intermediate nodes defined at varying altitudes;
determining the cost associated with traversing each of the plurality of paths; and
selecting the path that satisfies a predetermined cost function.

13. The method of claim 12 wherein defining a plurality of paths comprises defining a plurality of intermediate nodes.

14. The method of claim 12 wherein selecting the path that satisfies a predetermined cost function comprises selecting the path having the least cost of arriving at the destination node.

15. The method of claim 12 wherein selecting the path that satisfies a predetermined cost function comprises selecting the path that satisfies a required time of arrival at the destination node.

16. The method of claim 12 wherein selecting the path that satisfies a predetermined cost function comprises selecting the path that satisfies a required time of arrival at the destination node, wherein satisfaction of the required time of arrival comprises iteratively adjusting the cost function.

17. A method of determining a route between an origin and a destination for a vehicle taking into account variables as it moves along the route, the method comprising:
establishing a plurality of nodes in a three dimensional grid encompassing the origin and destination;
beginning at the origin node, determining costs of moving the vehicle to multiple nodes proximate to the origin node;
from each of the multiple nodes, determining transition costs of moving to further multiple nodes as a function of the variables;
varying altitude in response to three dimensional hazard areas; and
repeatedly determining further costs from the nodes to create multiple routes between the origin and the destination.

18. The method of claim 17 and further including tracking the total cost from the origin to each of the nodes for which a cost is determined from a previous node.

19. The method of claim 18 and further including repeating the determination of costs to move to further nodes from a node previously reached only if the total cost to reach the node is less than the previous total cost to reach the node.

20. A system for determining a route between an origin and a destination, the system comprising:
means for determining multiple feasible segments beginning from the origin to a node at the end of each feasible segment;
means for varying altitude as a function of three dimensional representations of hazard areas;
means for iteratively determining further segments from the nodes to create multiple segment paths between the origin and the destination; and
means for determining the segment path between the origin and destination having the least cost.

21. The system of claim 20 wherein an hazard area is represented by a polygon having vertices in a lateral plane and a height.

22. The system of claim 21 wherein the hazard area is represented by multiple polygons having different heights.

23. The system of claim 21 wherein the hazard area is associated with a velocity vector.

24. The system of claim 20 wherein the hazard areas are selected from the group consisting of weather hazards, volcanic ash, special use airspace and politically sensitive regions.

25. The system of claim 20 wherein the hazard area is moved in accordance with a velocity vector during determination of the segment path.

26. A route planner comprising:
a module implementing a recursive algorithm to determine a horizontal path;
a module implementing an adaptive algorithm to determine a vertical path that is adjusted based on hazzard areas represented by horizontal polygons having top and bottom altitudes.
